(19) United States
(12) Patent Application Publication
(10) Pub. No.: US 2025/0356513 A1
(43) Pub. Date: Nov. 20, 2025

(54) DEPTH ESTIMATION BASED ON RELATIONSHIPS IN TWO-DIMENSIONAL AND THREE-DIMENSIONAL SPACE FOR AUTONOMOUS SYSTEMS AND APPLICATIONS

(71) Applicant: NVIDIA Corporation, Santa Clara, CA (US)

(72) Inventors: Hopyong Gil, Suwon-si (KR); Bala Siva Sashank Jujjavarapu, Sunnyvale, CA (US); Seungwoo Yoo, Yongin (KR); Sangmin Oh, San Jose, CA (US); Minwoo Park, Saratoga, CA (US)

(21) Appl. No.: 18/664,737

(22) Filed: May 15, 2024

(51) Int. Cl. G06T 7/50; G06T 7/70

(52) U.S. Cl. CPC G06T 7/50; G06T 7/70

(57) ABSTRACT

In various examples, depth predictions obtained using machine learning models may be improved by leveraging relationships associated with two-dimensional (2D) images and three-dimensional (3D) environments. For instance, systems and methods are disclosed that may generate and use a depth distribution map as an additional input channel to a machine learning model. This depth distribution channel may represent average depth values for respective pixels of 2D images generated using a sensor. Additionally, or alternatively, the disclosed systems and methods may generate and use a 2D coordinate channel (e.g., Y coordinate channel) that is aligned with depth in 3D space. For example, the 2D coordinate channel may include points having values that increase in magnitude from a bottom portion of a frame to a top portion of the frame. One or more of these channels may then be applied to the machine learning model to improve depth predictions.

### BACKGROUND

Effectively perceiving a surrounding environment using sensors is an essential element for various autonomous or semi-autonomous functionalities and tasks. In various instances, perception techniques may rely on a combination of sensors—such as cameras, LiDARs, RADARs, and/or ultrasonic sensors—to collect data from the environment. This data may then be processed using advanced algorithms and/or artificial intelligence to identify objects, detect obstacles, assess traffic conditions, among other operations. Through this complex process, autonomous vehicles may be able to navigate safely, make informed decisions, and avoid collisions.

In some instances, these perception techniques may include using machine learning models and/or other algorithms to estimate depth for constructing or understanding a three-dimensional (3D) scene from one or more two-dimensional (2D) images. However, conventional systems may lack inherent awareness of locations within an image during processing. For instance, unlike LiDAR, RADAR, and/or other modalities of sensor data that may inherently contain depth information, camera images generally lack absolute scale information. Thus, using these conventional systems to accurately predict depth values solely from 2D camera images may pose a significant challenge due to scale ambiguity.

### SUMMARY

Embodiments of the present disclosure relate to depth estimation based on relationships in two-dimensional (2D) and three-dimensional (3D) space for autonomous and/or semi-autonomous systems and applications. For instance, systems and methods are disclosed herein that may generate and use a depth distribution map as an additional input channel to a machine learning model. This depth distribution channel may represent average depth values for respective points (e.g., pixels) included in 2D image data. For example, the depth distribution map may be generated based at least on ground truth data including one or more average measurements of depth, distance, etc. associated with one or more locations in an environment that correspond to the respective points included in the 2D image data. Additionally, or alternatively, the disclosed systems and methods may generate and use one or more 2D coordinate channels (e.g., Y coordinate channel, X coordinate channel, etc.) that is aligned with depth in 3D space. For example, the 2D coordinate channel for a vertical (e.g., Y) coordinate may include points having values that increase in magnitude from a bottom portion of a 2D image frame to a top portion of the frame. That is, the values of the points for the vertical coordinates may increase from, for instance, 0 to 1 linearly or nonlinearly from the bottom of the frame to the top of the frame, similar to how 3D depth of a 2D image may increase, in some instances, from the bottom of an image to the top of the image. In any example, one or more of these channels and/or other channels described herein may then be applied to one or more machine learning models (e.g., deep neural networks) to improve their depth predictions based on 2D images.

In contrast to conventional systems, the systems of the present disclosure, in some embodiments, are able to provide more informative data as a hint to a machine learning model for depth estimation tasks performed during both training and inference phases. As such, and as described in more detail herein, by performing such processes, such as generating the depth distribution channel and/or the 2D-to-3D aligned coordinate channels, the systems of the present disclosure are able to enhance the quality/accuracy of 3D depth predictions output using a machine learning model—based on processing 2D image data, alone, in embodiments—during both training and inference phases. This provides improvements over the conventional systems for depth estimation that do not leverage established priors and advantageous relationships for depth estimation. Additionally, the systems of the present disclosure may be capable of providing absolute scale for accurate depth prediction results, as well as depth-friendly coordinate information which can be strong clues to let models and/or convolution layer kernels know which part of an image is being processed.

### BRIEF DESCRIPTION OF THE DRAWINGS

The present systems and methods for depth estimation based on relationships in two-dimensional (2D) and three-dimensional (3D) space for autonomous and/or semi-autonomous systems and applications are described in detail below with reference to the attached drawing figures, wherein:

FIG. 1 is a data flow diagram illustrating an example process for estimating depth in images based on relationships between 2D and 3D space, in accordance with some embodiments of the present disclosure;

FIG. 2A illustrates an example of an image of an environment, in accordance with some embodiments of the present disclosure;

FIG. 2B illustrates an example of points that may be included in an image frame, in accordance with some embodiments of the present disclosure;

FIG. 2C illustrates an example of various depths associated with respective locations in a 3D space that correspond to the points included in the image frame, in accordance with some embodiments of the present disclosure;

FIG. 3 illustrates an example of a coordinate channel, in accordance with some embodiments of the present disclosure;

FIGS. 4A and 4B illustrate examples of depth channels, in accordance with some embodiments of the present disclosure;

FIG. 5 illustrates example detail associated with a process for concatenating one or more input tensors with coordinate channels and a depth channel, in accordance with some embodiments of the present disclosure;

FIG. 6 is a data flow diagram illustrating an example process for training one or more machine learning models using input data that includes a depth channel and/or one or more 2D coordinate channels, in accordance with some embodiments of the present disclosure;

FIG. 7 is a flow diagram illustrating an example method for using a machine learning model to predict 3D depth from 2D images based at least on leveraging a depth channel input, in accordance with some embodiments of the present disclosure;

FIG. 8 is a flow diagram illustrating an example method for applying a depth channel and/or a 2D coordinate channel to a machine learning model, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

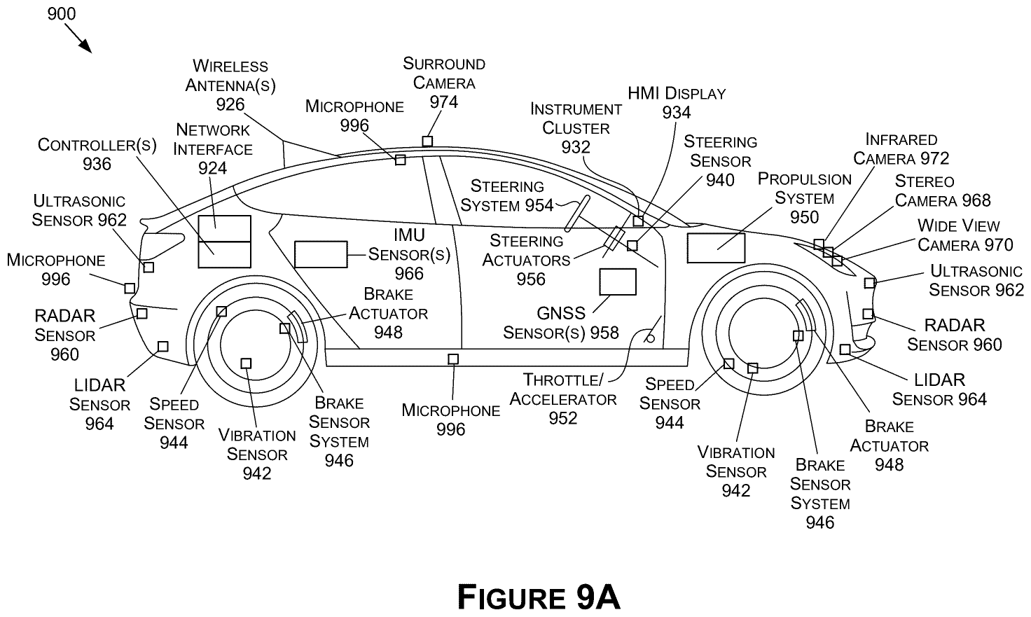

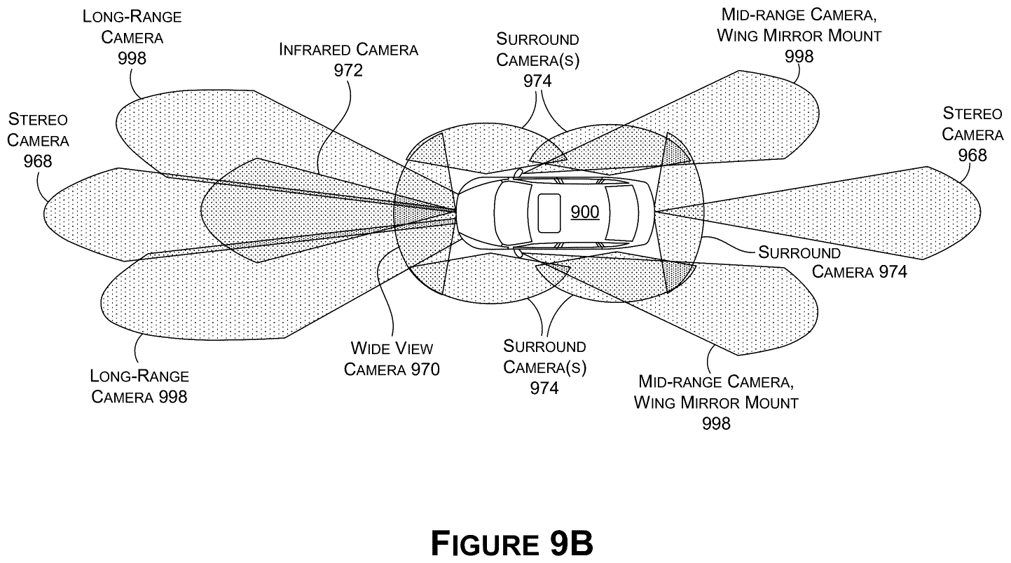

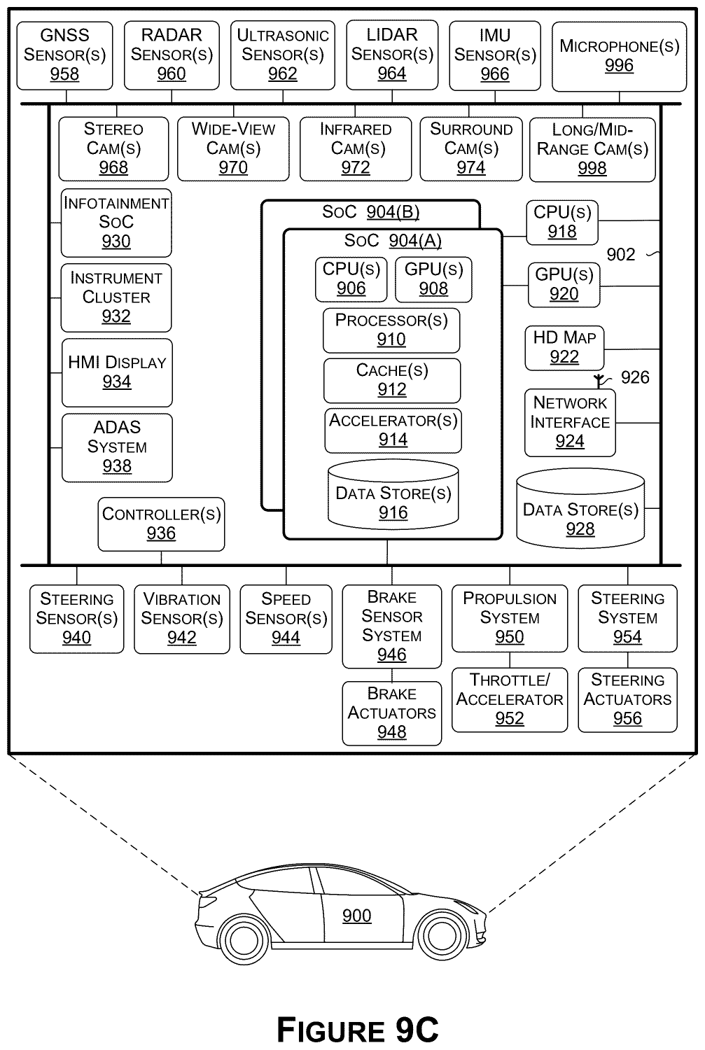

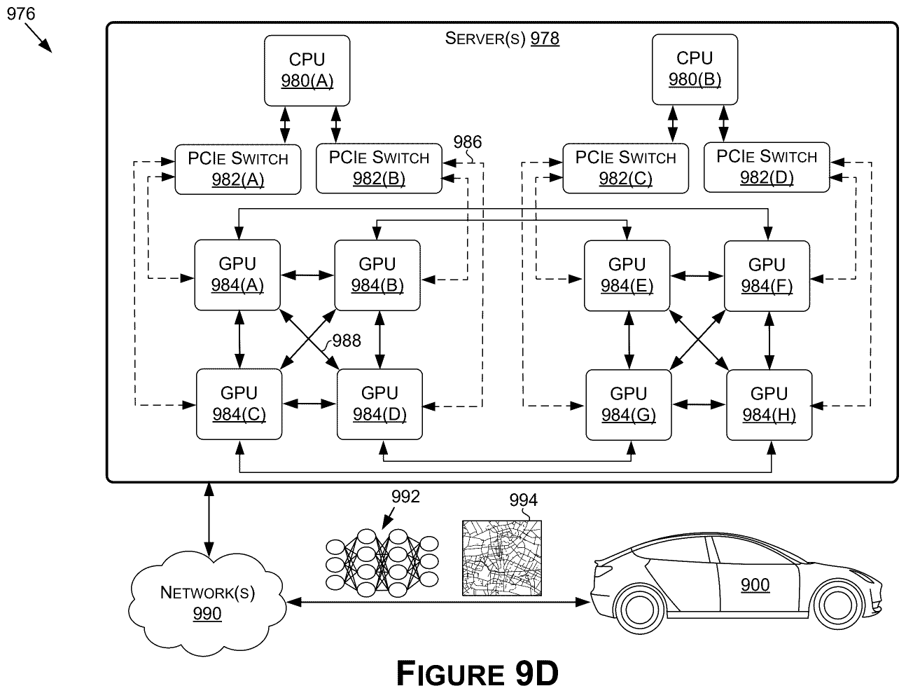

Systems and methods are disclosed related to depth estimation based on relationships in two-dimensional (2D) and three-dimensional (3D) space for autonomous and/or semi-autonomous systems and applications. Although the present disclosure may be described with respect to an example autonomous or semi-autonomous vehicle or machine 900 (alternatively referred to herein as “vehicle 900,” “ego-vehicle 900,” “ego-machine 900,” or “machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to depth estimation, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

As described herein, a system(s) may, in some examples, modify the architecture of a deep neural network (DNN) and/or other machine learning model to enhance the ability of convolutional kernels to accurately predict depth for each point (e.g., pixel or group of pixels) included in one or more input images. Conventionally, convolutional kernels may operate on an input tensor using a sliding window method, sharing the same weights. However, these kernels may typically be limited to perceiving only a restricted image patch within their receptive field, lacking awareness of their spatial position within the image. Accordingly, the disclosed system(s) may augment the input tensor with one or more additional channels, as described herein. This additional channel(s) may be used to provide, among other things, mean depth information for specific sensors and/or depth-friendly coordinate information, which may correlate more directly with 3D depth than traditional 2D image coordinates. This augmentation may serve as a valuable hint for depth estimation tasks, enabling models to recognize where the region of an image is being processed relative to 3D space, as well as enabling the models to leverage historical tendencies for certain sensors.

For instance, the system(s) may generate one or more 2D coordinate channels to be included as one or more additional channels of an input tensor applied to a machine learning model (e.g., neural network, deep neural network, convolutional neural network, etc.). The 2D coordinate channel(s) may include one or more first coordinate channels corresponding to a first 2D coordinate and one or more second coordinate channels corresponding to a second 2D coordinate. For instance, the first coordinate channel(s) may correspond to horizontal coordinates (e.g., X-coordinates) and the second coordinate channel(s) may correspond to vertical coordinates (e.g., Y-coordinates). Additionally, or alternatively, the 2D coordinate channel(s) may correspond to other coordinate systems as well, such as polar coordinate systems (e.g., r, θ) and/or any other 2D coordinate system.

In some examples, an X-coordinate channel of the 2D coordinate channel(s) may include a frame of image data including points having values that vary linearly or non-linearly between a first portion of the frame and a second portion of the frame. For instance, one or more first values of one or more first points (e.g., pixels) disposed on a first side (e.g., left) of the frame may have a magnitude of “−1” (and/or any other value) while one or more second values of one or more second points disposed on a second side (e.g., right) of the frame opposite the first side may have a value of “1” (and/or any other value that is greater than the value of the first side) In some examples, the values of the points in the X-coordinate channel may correspond to one or more locations in a 3D space. For instance, and continuing the above example in which the values vary from −1 to 1 from left to right of the frame, points having values less than “0” (e.g., −1 to 0) may be located left of a center of the frame, while points having values greater than 0 (e.g., 0 to 1) may be located right of the center of the frame. In this way, a convolutional kernel operating on an input tensor and perceiving a restricted image patch may have awareness of the image patch's spatial position within the image.

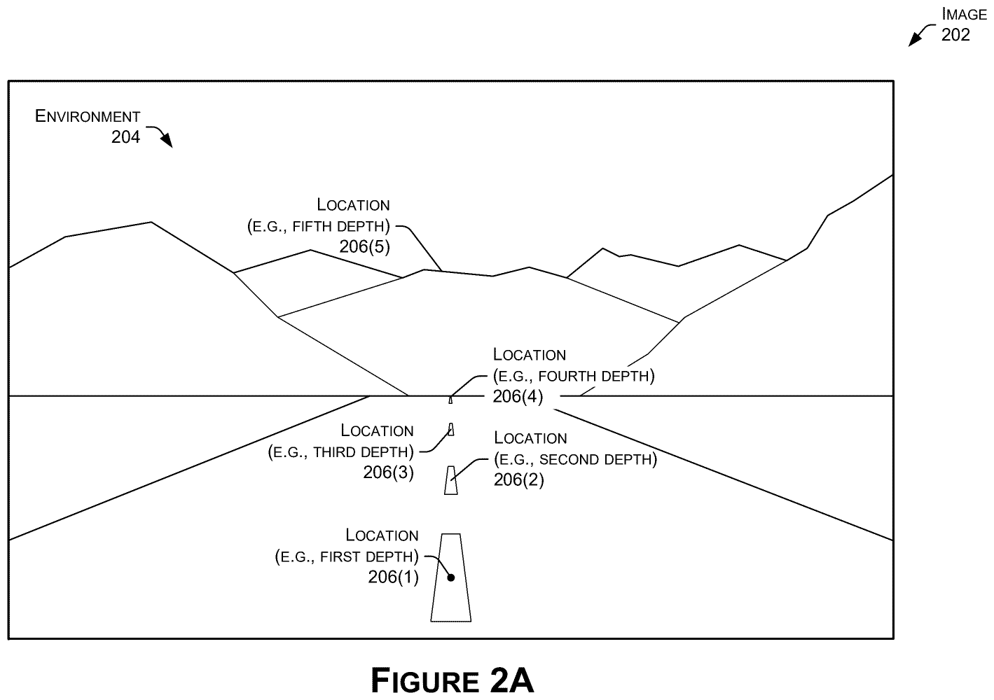

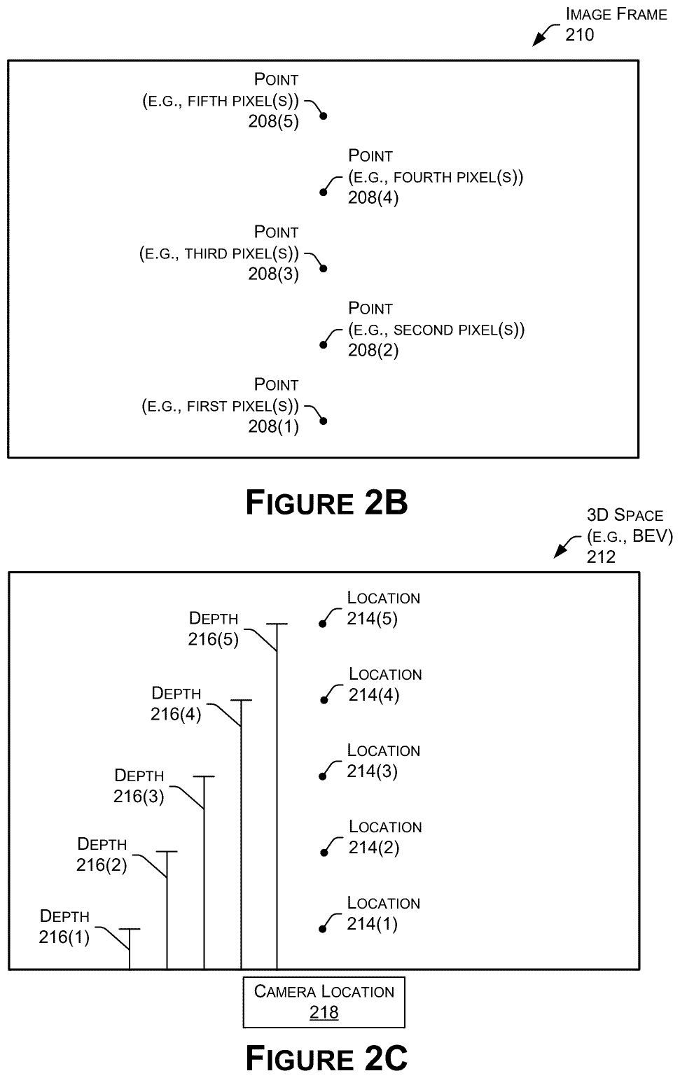

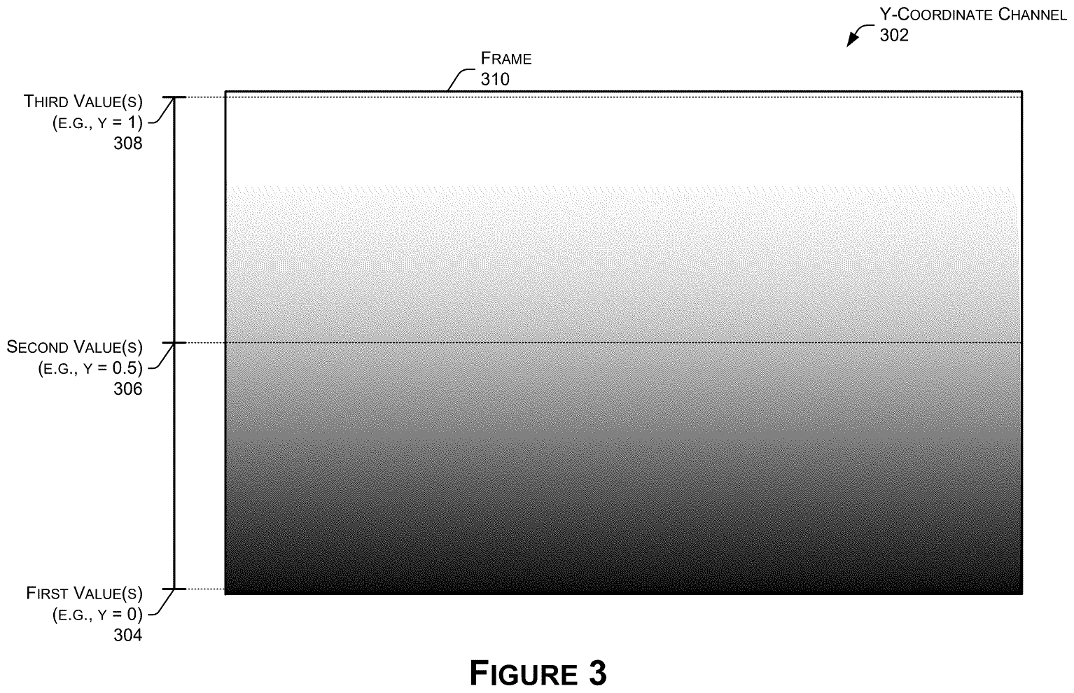

In some instances, a Y-coordinate channel of the 2D coordinate channel(s) may similarly include a frame of image data including points having values that increase in magnitude linearly or nonlinearly between a first portion of the frame (e.g., bottom) and a second portion of the frame (e.g., top). For instance, values of points (e.g., pixels) disposed at the bottom of the frame may have a magnitude of “0” (and/or any other value), while values of points disposed at the top of the frame may have a value of “1” (and/or any other value that is greater than the value of the bottom of the frame). In some examples, the values of the points in the Y-coordinate channel may also correspond to one or more locations in the 3D space. That is, a relationship may exist between values of the points in the Y-coordinate channel and depth values associated with locations corresponding to the Y-coordinate channel points in 3D space. For instance, and continuing the above example in which the values vary from 0 to 1 from bottom to top of the frame, points having values less than “0.5” (e.g., 0 to 0.5) may have lower depth values (e.g., located closer to the sensor in 3D), while points having values greater than 0.5 (e.g., 0.5 to 1) may have greater/larger depth values (e.g., located further from the sensor in 3D space). That is, the 2D coordinate Y, in some instances, may align with depth when assuming a flat ground. For instance, the bottom of an image may usually be closer to a camera/sensor while the top of the image may usually be farther away from the camera/sensor, as explained in further detail below in FIGS. 2A-2C. Thus, the system(s) may generate the Y-coordinate channel to align with depth in the 3D world, providing more straightforward cues for depth estimation.

In addition to—or in the alternative of—generating the one or more 2D coordinate channels, the system(s) may generate data representing one or more depth distribution maps to be included as the additional channel(s) of the input tensor applied to the machine learning model. The depth distribution map(s) may be representative of a mean depth value for each pixel of one or more input images captured using one or more sensors (e.g., cameras). For instance, the depth distribution map(s) may be indicative of one or more distances (e.g., mean or average distances) associated with one or more locations in an environment that correspond to one or more pixels included in one or more input images. That is, throughout a plurality of images generated using a sensor, a certain pixel may correspond to various locations in an environment, and the depth distribution map(s) may indicate an average distance between the sensor and those various locations that correspond to that certain pixel, as well as for one or more other pixels of the plurality of images.

In some examples, each point (e.g., pixel) of the depth distribution map(s) may have a respective depth value representing that points average depth for that specific sensor. That is, in some examples, the depth distribution map(s) may be sensor specific. For instance, because different sensors may have different fields of view and/or be positioned at different angles or orientations, the depth distribution map(s) may vary from one sensor to another. As an example, a first depth distribution map for a backup camera of a vehicle, which may include a wide-angle lens and be oriented at a downward angle, may include different per-pixel depth values than a second depth distribution map for a forward-facing camera of the vehicle, which may include a standard lens and be oriented substantially horizontal to the ground.

In some examples, the mean depth values for the depth distribution map(s) may be computed from ground truth data and/or by analyzing one or more images captured using a specific sensor at various locations in an environment. For instance, measured depths for each pixel in the ground truth and/or the image(s) may be averaged to compute the mean depth values. As an example, assume that a specific pixel included in a series of 10 images has measured depth values that correspond to locations in the environment that are at distances of 10 feet in six of the images, 8 feet in two of the images, and 12 feet in the remaining two images. In such a scenario, the depth value for that pixel in the depth distribution for that sensor may be computed as 10 feet. This process may be repeated and/or executed in parallel for every pixel of the series of images to compute the depth distribution map for that sensor. In various examples, by including the depth distribution map(s) as the additional input channel(s), convolutional kernels may get an absolute depth scale reference derived from entire scene data, thereby enhancing depth estimation accuracy.

In some examples, the system(s) may train one or more machine learning models to predict 3D depth based on 2D image inputs/tensors that may be augmented to include the additional channel(s), such as the depth channel(s) and/or the 2D coordinate channel(s). Additionally, the system(s) may use the machine learning model(s) in an inference phase to make predictions about 3D depth from 2D images using the additional channel(s). In such an inference phase, the system(s) may use the predictions about the 3D depth to control operation of one or more autonomous or semi-autonomous machines or vehicles.

For instance, the system(s) may obtain sensor data (e.g., image data) representing one or more images of an environment. In some instances, the sensor data may be captured or otherwise generated using one or more sensors (e.g., cameras) associated with an autonomous or semi-autonomous machine or vehicle that is operating in the environment. The system(s) may apply the sensor data to one or more machine learning models. In some examples, the system(s) may use one or more pre-processing components to process the sensor data and generate one or more input tensors to be applied to one or more layers of the machine learning model(s), such as one or more convolutional layers, one or more attention layers, one or more pooling layers, and/or any other layers. Additionally, an in accordance with the technologies disclosed herein, the system(s) may modify the input tensor(s) to include the additional channel(s), which may correspond to one or more of the depth distribution map(s) and/or the 2D coordinate channel(s). For instance, the system(s) may augment the input tensor(s) with the additional channel(s), and then cause the modified input tensor(s) to be applied to the convolutional layer(s) of the machine learning model(s).

Based at least on applying the modified input tensor(s) to the convolutional layer(s) of the machine learning model(s), the system(s) may determine one or more depth values associated with one or more objects in the environment. For instance, the one or more objects may be depicted in the image(s) of the environment, and the system(s) may use the machine learning model(s) in accordance with the technologies disclosed herein to determine the depth value(s) associated with those object(s), as well as potentially other information associated with the object(s), such as a location(s) associated with the object(s), a classification(s) associated with the object(s), a trajectory(ies) associated with the object(s), a bounding shape(s) and/or a size(s) associated with the object(s), and/or the like.

In some examples, the system(s) may also perform one or more operations associated with the machine (e.g., autonomous or semi-autonomous machine or vehicle) based at least on the one or more depth values and/or other predictions. For instance, the system(s) may control a trajectory of the machine based at least on the depth value(s). Additionally, or alternatively, the system(s) may provide the depth value(s) and/or other predictions to one or more downstream components of the machine, such as a planning component for planning a trajectory of the machine. In some examples, the system(s) may further cause one or more other machines (e.g., other autonomous or semi-autonomous machines or vehicles) to perform operations based at least on the depth value(s) and/or other predictions. For instance, the depth value(s) may be used by the system(s) to determine that a route is no longer valid, and the system(s) may send a notification to the other machine(s) to indicate the route is invalid.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs) or vision language models (VLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

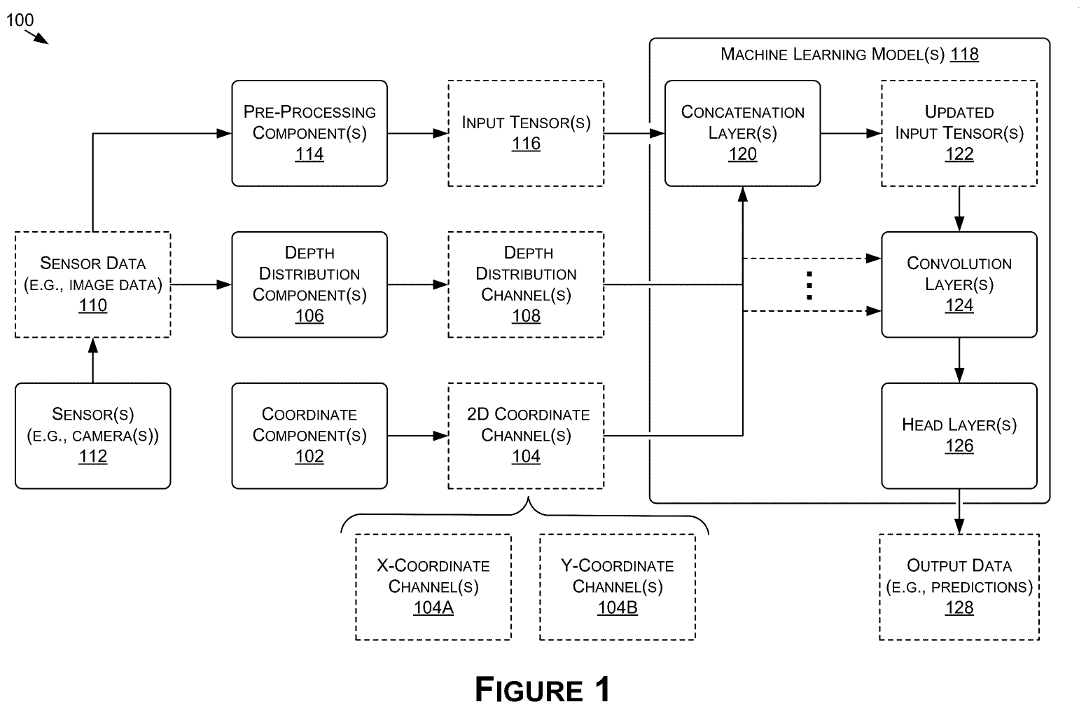

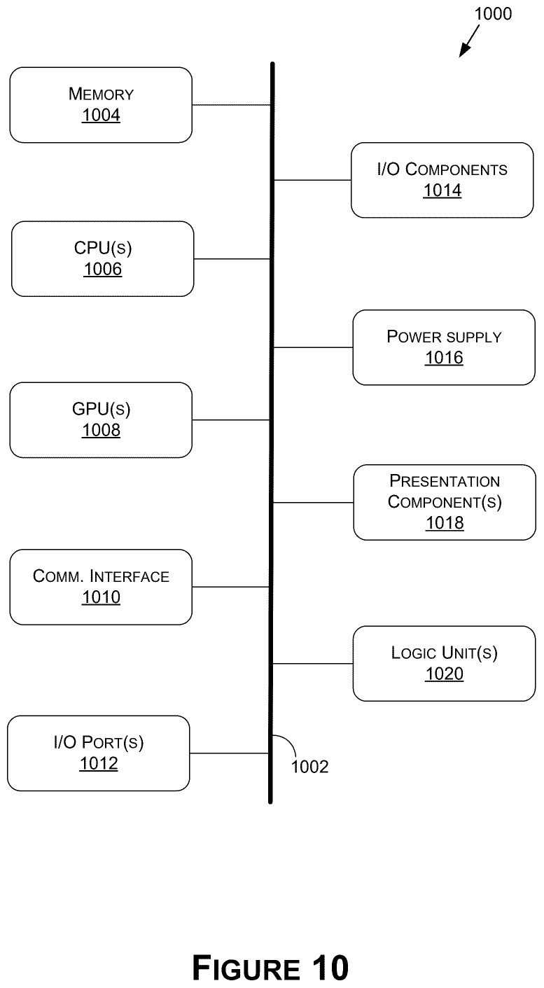

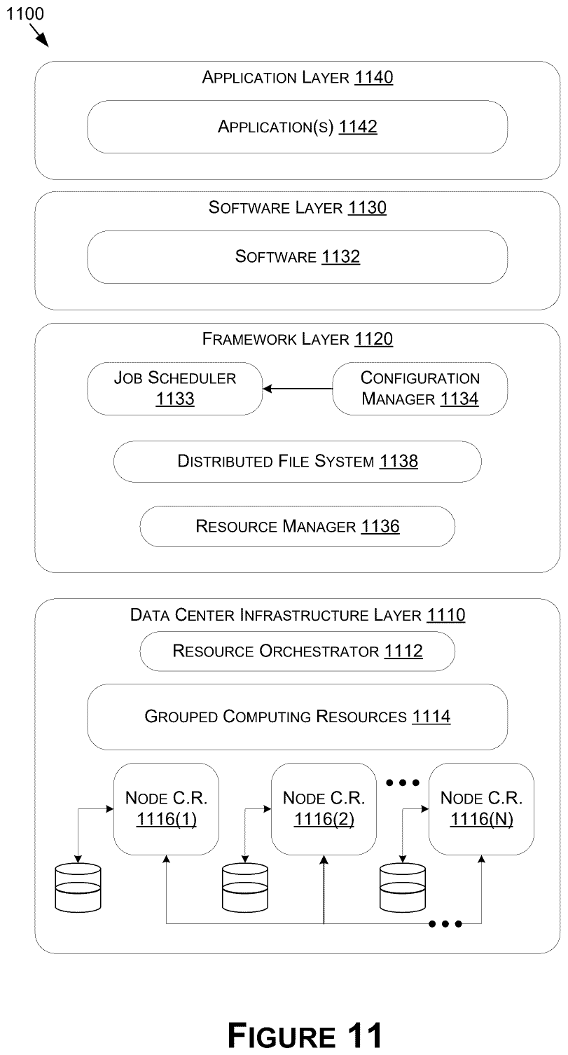

With reference to FIG. 1, FIG. 1 is a data flow diagram illustrating an example process 100 for estimating depth in images based on relationships between 2D and 3D space, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

The process 100 includes one or more coordinate components 102 that generate one or more 2D coordinate channels 104, which may include one or more X-coordinate channels 104A and/or one or more Y-coordinate channels 104B. The process 100 may also include one or more depth distribution component(s) 106 that generate one or more depth distribution channels 108 based at least on sensor data 110 received from one or more sensors 112. The process 100 may further include one or more pre-processing components 114 that generate one or more input tensors 116 based at least on the sensor data 110 received from the sensor(s) 112. The 2D coordinate channel(s) 104, the depth distribution channel(s) 108, and/or the input tensor(s) 116 may then be applied to one or more concatenation layers 120 (which may perform concatenation, or may combine information using other techniques, such as stacking, adding, etc.) and/or any other layer(s) of one or more machine learning models 118. The concatenation layer(s) 120 may generate one or more updated input tensors 122 based at least on the input tensor(s) 116, the depth distribution channel(s) 108, and/or the 2D coordinate channel(s) 104. The process 100 may then include applying the updated input tensor(s) 122 to one or more convolution layer(s) 124 and to one or more head layers 126 of the machine learning model(s) 118. The head layer(s) 126 of the machine learning model(s) 118 may then generate output data 128 based at least on data obtained from the convolution layer(s) 124. The output data 128 may include one or more predictions associated with the sensor data, such as depth values associated with one or more pixels included in one or more images.

As mentioned above, the coordinate component(s) 102 may generate the 2D coordinate channel(s) 104. The 2D coordinate channel(s) 104 may include the X-coordinate channel 104A and/or the Y-coordinate channel 104B. Additionally, or alternatively, the 2D coordinate channel(s) 104 may correspond to other coordinate systems as well, such as polar coordinate systems (e.g., r, θ) and/or any other 2D coordinate system. In some examples, the coordinate component(s) 102 may represent one or more coordinate convolution layers associated with the machine learning model(s) 118. The coordinate convolution layer(s) may accurately align coordinate values with depth in the 3D world. Unlike conventional coordinate convolution layers, which may merely represent 2D image coordinates and not directly address depth estimation tasks, the coordinate component(s) 102 may generate 2D coordinate values that are proportionate to 3D depth. That is, the coordinate component(s) 102 may align the X-axis and/or Y-axis with depth patterns observed in 2D images, such as how bottom portions of an image frame may tend to be closer to the camera than top portions of the image frame, in some cases.

For example, FIG. 2A illustrates an example of an image 202 of an environment 204, in accordance with some embodiments of the present disclosure. The image 202 of the example shown in FIG. 2A may illustrate a relationship between image frame locations and 3D depth in the environment 204. For instance, the locations 206(1)-206(5) (also referred to collectively as “locations 206”) in the environment 204 may each be associated with different depths/distances. The first location 206(1) in the environment 204 may correspond to a first depth (e.g., distance from the camera used to capture the image 202), the second location 206(2) may correspond to a second depth, the third location 206(3) may correspond to a third depth, the fourth location 206(4) may correspond to a fourth depth, and the fifth location 206(5) may correspond to a fifth depth. As illustrated, as the pixel positions corresponding to the locations 206 vary between the bottom of the image 202 to the top of the image 202 (e.g., as Y-coordinate values increase), the depth/distance of the locations 206 in the 3D environment 204 increases. For instance, the first depth associated with the first location 206(1) is less than the second depth associated with the second location 206(2), which is less than the third depth associated with the third location 206(3), and so forth.

Referring now to FIG. 2B, FIG. 2B illustrates an example of points 208(1)-208(5) (also referred to collectively as “points 208”) that may be included in an image frame 210, in accordance with some embodiments of the present disclosure. In some instances, the image frame 210 may correspond to the image 202 illustrated in the example of FIG. 2A. In various examples, each one of the points 208 may correspond to individual pixels and/or groups of pixels included in the image frame 210. For instance, the first point 208(1) may correspond to one or more first pixels, the second point 208(2) may correspond to one or more second pixels, the third point 208(3) may correspond to one or more third pixels, the fourth point 208(4) may correspond to one or more fourth pixels, and the fifth point 208(5) may correspond to one or more fifth pixels. Additionally, each one of the points 208 may correspond to one or more respective Y-coordinate and/or X-coordinate values. For instance, the first point 208(1) may correspond to one or more first Y-coordinate and/or X-coordinate values, the second point 208(2) may correspond to one or more second Y-coordinate and/or X-coordinate values, and so forth. As described herein, the points 208 of the image frame 210 may also correspond to one or more locations in an environment, such as the locations 214(1)-214(5) (also referred to collectively as “locations 214”) in the 3D space 212 illustrated in the example of FIG. 2C.

Referring now to FIG. 2C, FIG. 2C illustrates an example of various depths 216(1)-216(5) (also referred to collectively as “depths 216”) associated with respective locations 214 in a 3D space 312 that correspond to the points 208 included in the image frame 210, in accordance with some embodiments of the present disclosure. The 3D space 212 may represent a Bird's-Eye-View (e.g., top-down) image and/or plane that corresponds to the environment 204 illustrated in the example of FIG. 2A. In the 3D space 212, the first location 214(1) may correspond to the first point 208(1), the second location 214(2) may correspond to the second point 208(2), the third location 214(3) may correspond to the third point 208(3), the fourth location 214(4) may correspond to the fourth point 208(4), and the fifth location 214(5) may correspond to the fifth point 208(5). Based at least on the vertical position of the points 208 in the image frame 210, the locations 214 may have different depths 216 (e.g., depth values) relative to the camera location 218, which may be associated with a camera used to generate the image frame 210 corresponding to the image 202. For instance, the first location 214(1) may be located at the first depth 216(1) away from the camera location 218, the second location 214(2) may be located at the second depth 216(2) away from the camera location 218, the third location 214(3) may be located at the third depth 216(3) away from the camera location 218, the fourth location 214(4) may be located at the fourth depth 216(4) away from the camera location 218, and the fifth location 214(5) may be located at the fifth depth 216(5) away from the camera location 218.

Although illustrated in the example of FIG. 1 as being separate from the machine learning model(s) 118, in some examples, the coordinate component(s) 102, the depth distribution component(s) 106, and/or the pre-processing component(s) 114 may be included within the machine learning model(s) 118. For instance, the coordinate component(s) 102, the depth distribution component(s) 106, and/or the pre-processing component(s) 114 may correspond to one or more layers of the machine learning model(s) 118.

Now referring back to the example of FIG. 1, in some examples, the X-coordinate channel(s) 104A of the 2D coordinate channel(s) 104 may include a frame of image data including points having values that vary linearly or non-linearly between a first portion of the frame and a second portion of the frame. For instance, one or more first values of one or more first points (e.g., pixels) disposed on a first side (e.g., left) of the frame may have a magnitude of “−1,” while one or more second values of one or more second points disposed on a second side (e.g., right) of the frame opposite the first side may have a value of “1.” In some examples, the values of the points in the X-coordinate channel(s) 104A may correspond to one or more locations in 3D space. For instance, and continuing the above example in which the values vary from −1 to 1 from left to right of the frame, points having values less than “0” (e.g., −1 to 0) may be located left of a center of the frame, while points having values greater than 0 (e.g., 0 to 1) may be located right of the center of the frame.

Similarly, the Y-coordinate channel 104B of the 2D coordinate channel(s) 104 may include a frame of image data including points having values that increase in magnitude linearly or nonlinearly between a first portion of the frame (e.g., bottom) and a second portion of the frame (e.g., top). For instance, values of points (e.g., pixels) disposed at the bottom of the frame may have a magnitude of “0,” while values of points disposed at the top of the frame may have a value of “1.” In some examples, the values of the points in the Y-coordinate channel(s) 104B may also correspond to one or more locations in the 3D space. That is, a relationship may exist between values of the points in the Y-coordinate channel(s) 104B and depth values associated with locations corresponding to the points of the Y-coordinate channel(s) 104B in 3D space.

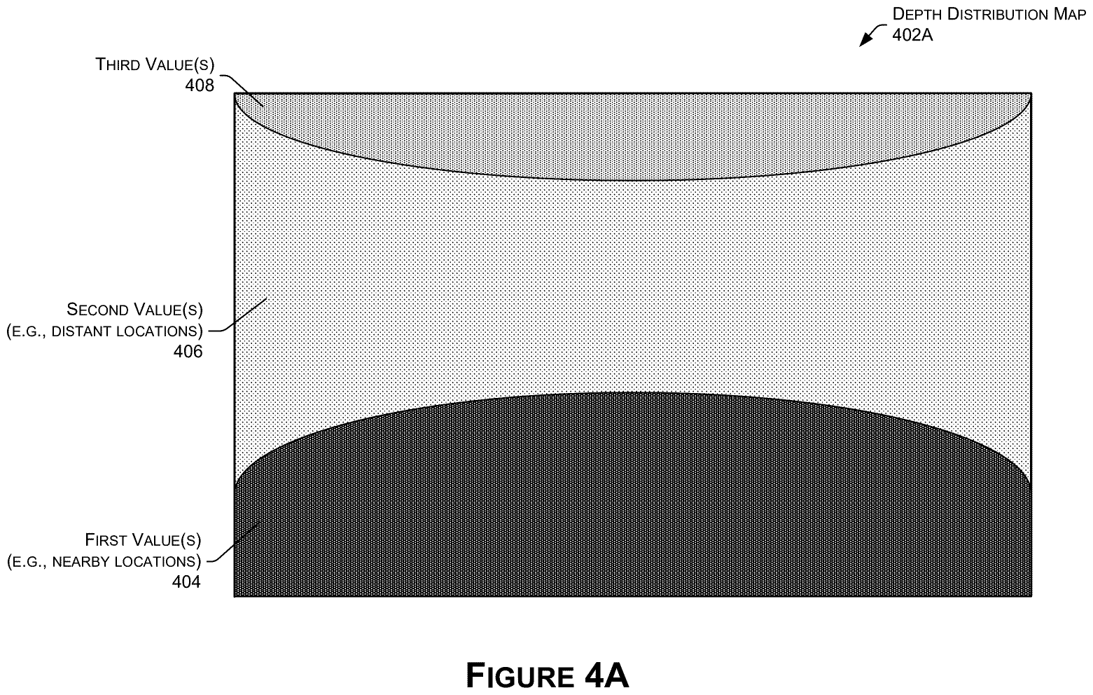

For instance, FIG. 3 illustrates an example of a Y-coordinate channel 302, in accordance with some embodiments of the present disclosure. The Y-coordinate channel 302 illustrated in FIG. 3 may correspond to the Y-coordinate channel 104B described in the example of FIG. 1. The Y-coordinate channel 302 may include multiple points or pixels, and the values of the points/pixels may increase in magnitude, linearly or nonlinearly, from the bottom of the frame 310 to the top of the frame 310, similar to how the depths 216 of the locations 214 corresponding to the points 208 increase from bottom to top of the image frame 210 in the examples of FIGS. 2B and 2C. For example, first points/pixels at the bottom of the frame 310 corresponding to the Y-coordinate channel 302 may have one or more first values 304 (e.g., Y=0), second points/pixels at the middle of the frame 310 may have one or more second values 306 (e.g., Y=0.5), and third points/pixels at the top of the frame 310 may have one or more third values 308 (e.g., Y=1). In some examples, variations in intensities, colors, and/or the like of the points/pixels of the Y-coordinate channel 302 may be used to indicate the Y-coordinate values of those points/pixels.

Referring back now to the example of FIG. 1, the process 100 may include the depth distribution component(s) 106 generating the depth distribution channel(s) 108. As with the 2D coordinate channel(s) 104, the depth distribution channel(s) 108 may also be applied to the machine learning model(s) 118. The depth distribution channel(s) 108 may be indicative of one or more distances (e.g., mean or average distances) associated with one or more locations in an environment that correspond to one or more pixels included in one or more input images. That is, throughout a plurality of images generated using the sensor(s) 112, a certain pixel of those images may correspond to various locations in an environment, and the depth distribution channel(s) 108 may indicate an average distance between the sensor(s) 112 and those various locations that correspond to that certain pixel, as well as for one or more other pixels of the plurality of images.

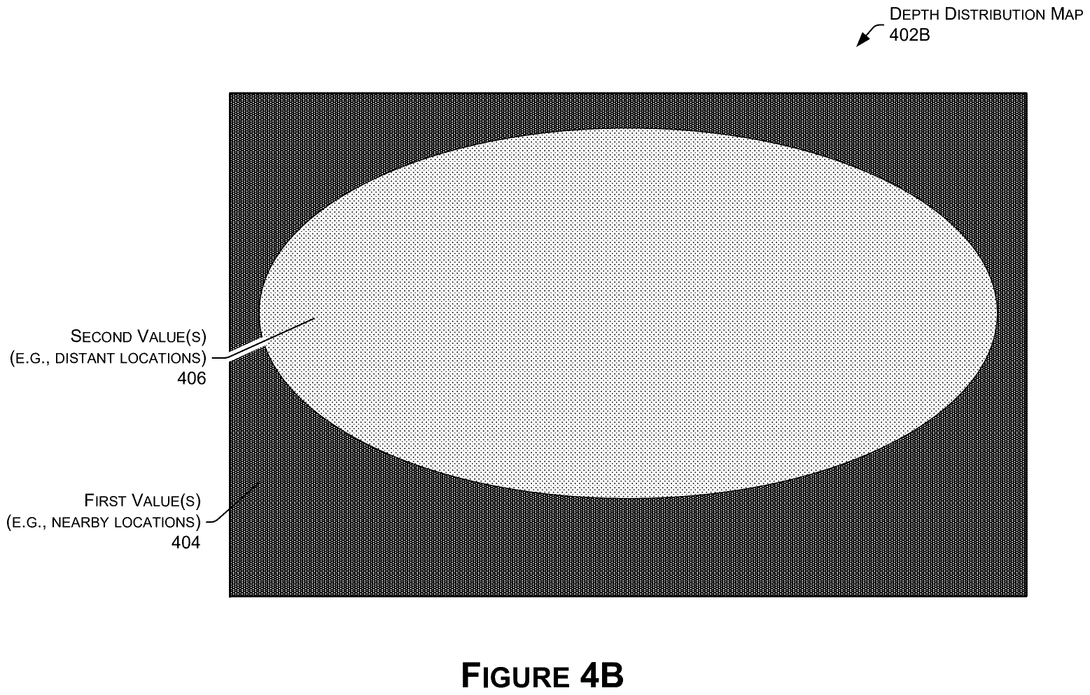

For example, FIG. 4A illustrates an example of a first depth distribution map 402A that could be included in the depth distribution channel(s) 108, in accordance with some embodiments of the present disclosure. The first depth distribution map 402A may include multiple points/pixels having values representative of average depths associated with those points/pixels. For instance, the first depth distribution map 402A may include first points/pixels having one or more first values 404, which may indicate that the first points/pixels, on average, correspond to nearby locations in an environment captured in images. Additionally, the first depth distribution map 402A may include second points/pixels having one or more second values 406, which may indicate that the second points/pixels, on average, correspond to more distant locations in the environment. Further, the first depth distribution map 402A may include third points/pixels having one or more third values 408, which may indicate that the third points/pixels, on average, correspond to locations in the environment that are at a distance somewhere in between the nearby locations and the distant locations.

In some examples, each point/pixel included in the depth distribution channel(s) 108 may have a respective depth value representing that point's average depth for a specific sensor. That is, in some examples, the depth distribution channel(s) 108 may be sensor specific. For instance, because different sensor(s) 112 may have different fields of view and/or be positioned at different angles or orientations, the depth distribution channel(s) 108 may vary from one sensor to another. As an example, a first depth distribution map for a backup camera of a vehicle, which may include a wide-angle lens and be oriented at a downward angle, may include different per-pixel depth values than a second depth distribution map for a forward-facing camera of the vehicle, which may include a standard lens and be oriented substantially horizontal to the ground.

For instance, the first depth distribution map 402A illustrated in the example of FIG. 4A may correspond to a first sensor of the sensor(s) 112. Referring now to FIG. 4B, FIG. 4B illustrates an example of a second depth distribution map 402B, which may correspond to a second sensor of the sensor(s) 112, in accordance with some embodiments of the present disclosure. The second depth distribution map 402B may include first points/pixels having one or more first values 404, which may indicate that the first points/pixels, on average, correspond to nearby locations in the environment. Additionally, the second depth distribution map 402B may include second points/pixels having one or more second values 406, which may indicate that the second points/pixels, on average, correspond to more distant locations in the environment. However, as can be seen by comparing the first depth distribution map 402A in FIG. 4A with the second depth distribution 402B of FIG. 4B, the values of the various points/pixels included therein may vary based on the underlying sensor's orientation, configuration, field of view, and/or the like.

In some examples, the mean depth values for the depth distribution maps 402A and 402B and/or the depth distribution channel(s) 108 may be computed from ground truth data and/or by analyzing the sensor data 110 captured using a specific sensor of the sensor(s) 112 at various locations in an environment. For instance, measured depths for each pixel in the ground truth and/or the sensor data 110 may be averaged to compute the mean depth values. As an example, assume that a specific pixel included in a series of 10 images has measured depth values that correspond to locations in the environment that are at distances of 10 feet in six of the images, 8 feet in two of the images, and 12 feet in the remaining two images. In such a scenario, the depth value for that pixel in the depth distribution for that sensor may be computed as 10 feet. This process may be repeated and/or executed in parallel for every pixel of the series of images to compute the depth distribution map for that sensor.

Referring back now to the example of FIG. 1, the process 100 may include the pre-processing component(s) 114 generating the input tensor(s) 116 based at least on the sensor data 110 obtained using the sensor(s) 112. In some examples, the sensor(s) 112 may include one or more sensors of one or more modalities. For example, the sensor(s) 112 may include one or more LiDAR sensors, one or more RADAR sensors, one or more image sensors (e.g., cameras), one or more ultrasonic sensors, and/or the like. As such, the sensor data 110 may include, in some examples, one or more modalities of sensor data. For instance, the sensor data 110 may include LiDAR data generated by the LiDAR sensor(s), RADAR data generated by the RADAR sensor(s), image data generated by the image sensor(s), ultrasonic data generated by the ultrasonic sensor(s), and/or the like. In some examples, the pre-processing component(s) 114 may perform one or more operations to process the sensor data 110 and generate the input tensor(s) 116. For example, the pre-processing component(s) 114 may perform one or more data cleaning operations, one or more normalization and/or scaling operations, one or more feature extraction operations, one or more data augmentation operations, one or more encoding operations, one or more data splitting operations, one or more data structuring operations, one or more batching and/or padding operations, and/or the like to convert the sensor data 110 into the input tensor(s) 116.

The process 100 may also include the concatenation layer(s) 120 of the machine learning model(s) 118 concatenating the 2D coordinate channel(s) 104 and/or the depth distribution channel(s) 108 with the input tensor(s) 116 to generate the updated input tensor(s) 122. That is, the concatenation layer(s) 120 may augment the input tensor(s) 116 with one or more of the 2D coordinate channel(s) 104 and/or the depth distribution channel(s) 108 prior to causing the updated input tensor(s) 122 to be applied to the convolutional layer(s) 124 of the machine learning model(s) 118.

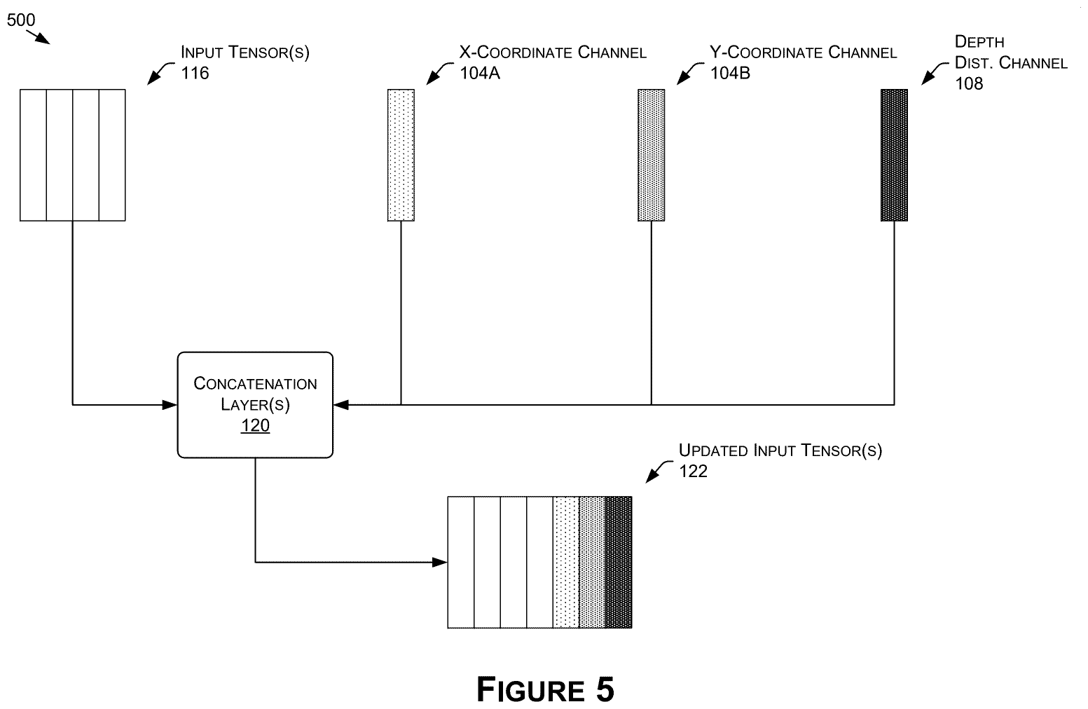

For instance, FIG. 5 illustrates example detail associated with a process 500 for augmenting one or more input tensors with coordinate channels and a depth channel, in accordance with some embodiments of the present disclosure. For instance, the concatenation layer(s) 120 may receive the input tensor(s) 116, the X-coordinate channel 104A, the Y-coordinate channel 104B, and/or the depth channel 108 and generate the updated input tensor(s) 122, which may include one or more of the input tensor(s) 116, the X-coordinate channel 104A, the Y-coordinate channel 104B, and/or the depth channel 108.

Referring back to the example of FIG. 1, the process 100 may include the updated input tensor(s) 122 being applied to the convolution layer(s) 124 of the machine learning model(s) 118. The convolution layer(s) 124 may process the updated input tensor(s) 122 to detect and extract features form the updated input tensor(s) 122. In some examples, the convolution layer(s) 124 may perform one or more feature detection operations, one or more convolution operations, one or more dimension reduction operations, one or more parameter sharing operations, one or more pooling and/or downsampling operations, and/or the like. Additionally, in some examples, the convolution layer(s) 124 may include one or more stacked layers, including, in some instances, one or more early layers and/or one or more deep layers. In some instances, the convolution layer(s) 124 may be followed by one or more nonlinear activation functions (not shown) to introduce non-linearity into the model(s), enabling the machine learning model(s) 118 to learn complex relationships and/or enhance the network's ability to classify and/or segment the data (e.g., the updated input tensor(s) 122).

The process 100 may also include the head layer(s) 126 of the machine learning model(s) 118 determining the output data 128. In some instances, the output data 128 may include one or more depth values (e.g., predicted depth values) associated with one or more objects in the environment. For instance, the one or more objects may be depicted in one or more image represented by the sensor data 110. Additionally, or alternatively, the output data 128 may include one or more other predictions, which may be based on the predicted depth value(s), such as a location(s) associated with the object(s), a classification(s) associated with the object(s), a trajectory(ies) associated with the object(s), a bounding shape(s) and/or a size(s) associated with the object(s), and/or the like.

In some examples, one or more machines, such as the vehicle 900 described below with respect to FIGS. 9A-9D, may perform one or more operations based at least on the output data 128 and/or the depth value(s). For instance, the vehicle 900 may determine a trajectory to follow based at least on the depth value(s). Additionally, or alternatively, a system(s) may provide the depth value(s) and/or other predictions to one or more components of the vehicle 900, such as a planning component for planning a trajectory of the machine. In some examples, the system(s) may further cause one or more other machines (e.g., other autonomous or semi-autonomous machines or vehicles) to perform operations based at least on the output data 128. For instance, the depth value(s) may be used by the system(s) to determine that a route is no longer valid, and the system(s) may send a notification to the other machine(s) to indicate the route is invalid.

Additionally, it should be appreciated that the additional channel(s) described herein—such as the depth distribution channel(s) 108, the 2D coordinate channel(s) 104, and/or any other channels—may be applied/added to an input tensor(s) of any layer(s) of the machine learning model(s) 118. For instance, the additional channel(s) may be added to one or more input tensors of one or more intermediate convolution layers, such as one or more of the input tensors applied to one or more of the convolution layer(s) 124. Additionally, the additional channel(s) may be applied to the various input tensors independent of one another, in some instances.

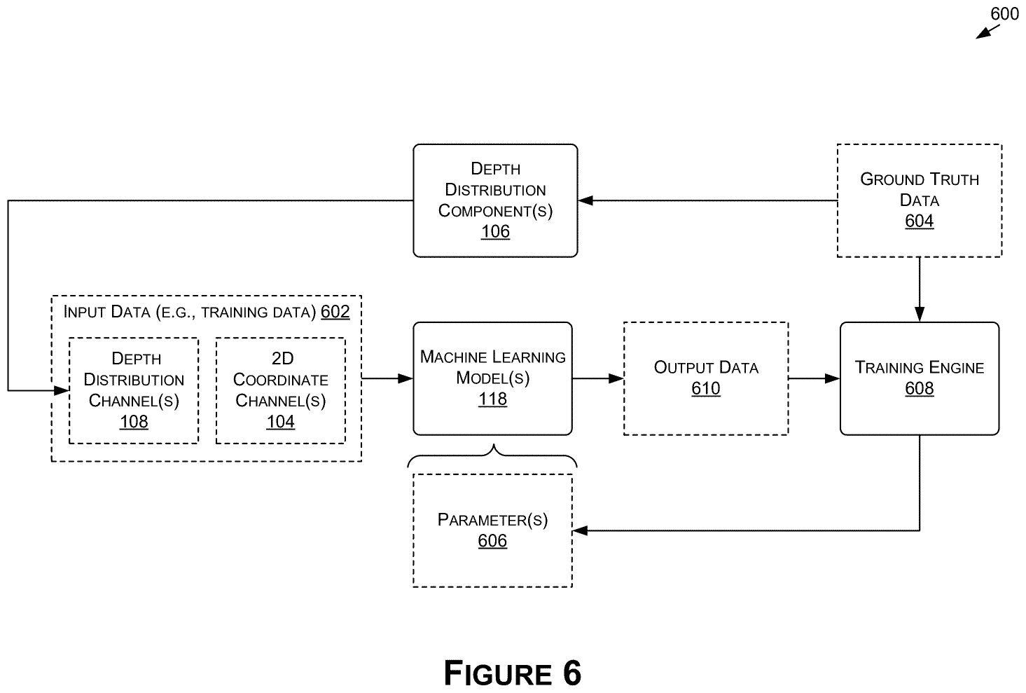

Now referring to FIG. 6, FIG. 6 is a data flow diagram illustrating an example process 600 for training one or more machine learning models using input data that may include the depth channel(s) 108 and/or the 2D coordinate channel(s) 104, in accordance with some embodiments of the present disclosure. As shown, the machine learning model(s) 118 may be trained using input data 602 (e.g., training data). The input data 602 may be similar to the updated input tensor(s) 122 described above with respect to FIG. 1. As such, the input data 602 may include the depth channel(s) 108 and/or the 2D coordinate channel(s) 104.

The machine learning model(s) 118 may be trained using the training input data 602 as well as corresponding ground truth data 604 (which may correspond to the input data 602). That is, although referred to as “ground truth data,” the ground truth data 604 may, in some examples, simply include the same data (e.g., images, etc.) as the input data 602. In some examples, the ground truth data 604 may include annotations, labels, masks, and/or the like. For example, in some embodiments, the ground truth data 604 may indicate actual values associated with the object(s) within the input data 602. For instance, and for an object, the values may include, but are not limited to, a x-coordinate location, a y-coordinate location, a z-coordinate location (e.g., depth measurements), a height, a width, a length, a density, attribute(s), and/or any other parameter. The ground truth data 604 may be generated within a drawing program (e.g., an annotation program), a computer aided design (CAD) program, a labeling program, another type of program suitable for generating the ground truth data 604, and/or may be hand drawn, in some examples. In any example, the ground truth data 604 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, the depth distribution component(s) 106 may generate a depth distribution(s) of the depth distribution channel(s) 108 based on the ground truth data 604.

A training engine 608 may use one or more loss functions that measure loss (e.g., error) in the output data 610 (which may include or otherwise be similar to the output data 128) generated by the machine learning model(s) 118 as compared to the ground truth data 604 and/or the input data 602. In some examples, the training engine 608 may compare the output data 610 from the machine learning model(s) 118 to the input data 602 and optimize the machine learning model(s) 118 based at least on the comparing. That is, the training engine 608 may update/optimize one or more parameters 606 associated with the machine learning model(s) 118 to reduce the losses/differences between the output data 610 and the input data 602. Any type of loss function may be used, such as cross entropy loss, mean squared error, mean absolute error, mean bias error, and/or other loss function types. In some examples, different outputs may have different loss functions. For example, the x-coordinate location may include a first loss, the y-coordinate location may include a second loss, the z-coordinate location may include a third loss, and/or so forth. In such examples, the loss functions may be combined to form a total loss, and the total loss may be used to train (e.g., update the parameter(s) 606 of) the machine learning model(s) 118. In any example, backward pass computations may be performed to recursively compute gradients of the loss function(s) with respect to training parameters. In some examples, weight and biases of the machine learning model(s) 118 may be used to compute these gradients.

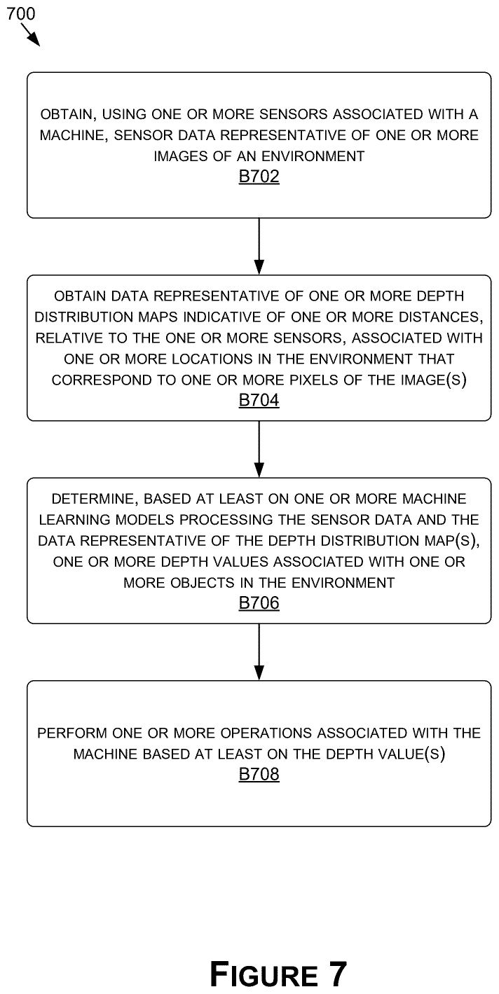

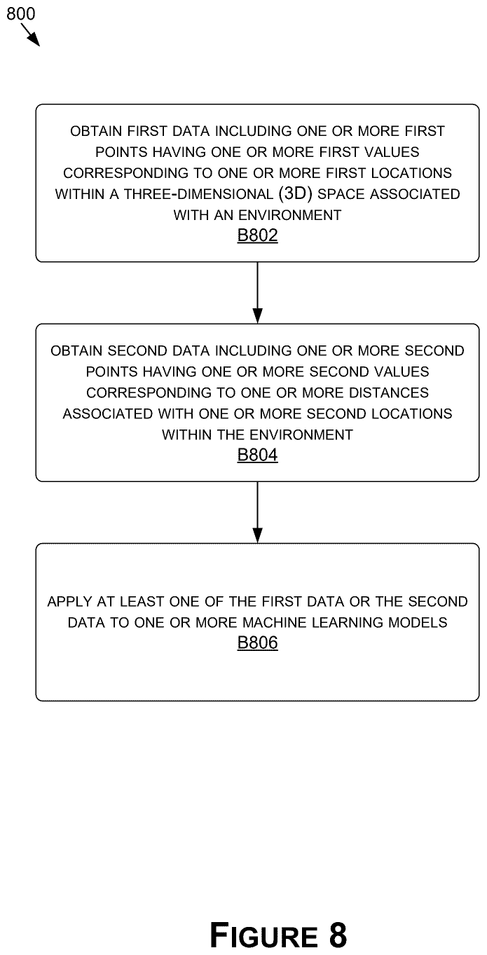

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700 and 800 are described, by way of example, with respect to FIG. 1. However, these methods may additionally or alternatively be executed by any one system, or any combination of systems, including, but not limited to, those described herein.

FIG. 7 is a flow diagram illustrating an example method 700 for using a machine learning model to predict 3D depth from 2D images based at least on leveraging a depth channel input, in accordance with some embodiments of the present disclosure. The method 700, at block B702, may include obtaining, using one or more sensors associated with a machine, sensor data representative of one or more images of an environment. For instance, the pre-processing component(s) 114 may obtain the sensor data 110 form the sensor(s) 112. As described herein, the sensor(s) 112 may include, among other sensors, on one or more image sensors and the sensor data 110 may include image data corresponding to the image(s) of the environment.

The method 700, at block B704, may include obtaining data representative of one or more depth distribution map s indicative of one or more distances, relative to the one or more sensors, associated with one or more locations in the environment that correspond to one or more pixels of the image(s). For instance, the concatenation layer(s) 120 may obtain the depth distribution channel(s) 108 indicative of the distance(s), relative to the sensor(s) 112, associated with the location(s) in the environment that correspond to the pixel(s) of the image(s). Additionally, in some examples, the concatenation layer(s) 120 may obtain the 2D coordinate channel(s) 104.

The method 700, at block B706, may include determining, based at least on one or more machine learning models processing the sensor data and the data representative of the depth distribution map(s), one or more depth values associated with one or more objects in the environment. For instance, the machine learning model(s) 118 (e.g., the convolution layer(s) 124 and/or the head layer(s) 126) may process the updated input tensor(s) 122—which may include the sensor data 110 and the depth distribution channel(s) 108 representative of the depth distribution map(s)—and generate the output data 128, which may include the depth value(s) associated with the object(s) in the environment.

The method 700, at block B708, may include performing one or more operations associated with the machine based at least on the depth value(s). For instance, the vehicle 900 may perform one or more operations based at least on the depth value(s), which may be included in the output data 128. In various examples, operation(s) associated with the machine may include determining a trajectory for the machine to follow based at least on the depth value(s). In some examples, the operation(s) may further include causing one or more other machines (e.g., other autonomous or semi-autonomous machines or vehicles) to perform operations based at least on the depth value(s). For instance, the depth value(s) may be used to determine that a route(s) is no longer valid, that a map feature(s) is incorrect, and/or the like, and a notification may be sent to the other machine(s) to indicate the route(s) is invalid and/or the map feature(s) is incorrect.

FIG. 8 is a flow diagram illustrating an example method 800 for applying a depth channel and/or a 2D coordinate channel to a machine learning model, in accordance with some embodiments of the present disclosure. The method 800, at block B802, may include obtaining first data including one or more first points having one or more first values corresponding to one or more first locations within a three-dimensional (3D) space associated with an environment. For instance, the concatenation layer(s) 120 of the machine learning model(s) 118 may obtain the 2D coordinate channel(s) 104, such as the X-coordinate channel(s) 104A and/or the Y-coordinate channel(s) 104B, which may include the first point(s) having the first value(s) corresponding to the first location(s) within the 3D space associated with the environment. In some examples, the first value(s) of the first point(s) may represent a relationship between the first location(s) in the 3D space and pixel locations in an image frame.

The method 800, at block B804, may include obtaining second data including one or more second points having one or more second values corresponding to one or more distances associated with one or more second locations within the environment. For instance, the concatenation layer(s) 120 of the machine learning model(s) 118 may obtain the depth distribution channel(s) 108 which may include the second point(s) having the second value(s) corresponding to the distance(s) associated with the second location(s) within the environment. In some examples, the second value(s) of the second point(s) corresponding to the distance(s) may be representative of average depths, in 3D space relative to a sensor, associated with pixels in image frames that correspond to the second point(s)

The method 800, at block B806, may include applying at least one of the first data or the second data to one or more machine learning models. For instance, the concatenation layer(s) 120 of the machine learning model(s) 118 may apply the updated input tensor(s) 122 to the convolution layer(s) 124 of the machine learning model(s) 118. The updated input tensor(s) 122, in some instances, may include the first data and/or the second data. That is, the updated input tensor(s) 122 may include one or more channels corresponding to the depth distribution channel(s) 108, the 2D coordinate channel(s) 104, and/or the original channels of the input tensor(s) 116.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to enable the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to enable autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LIDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation enabling any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LIDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 912 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to enable communication with peripherals, audio codecs, power management, and/or other devices. The SoC(s) 904 may be used to process data from cameras (e.g., connected over Gigabit Multimedia Serial Link and Ethernet), sensors (e.g., LIDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LIDAR sensor(s) 964. The LIDAR sensor(s) 964 may be used for object and pedestrian detection, emergency braking, collision avoidance, and/or other functions. The LIDAR sensor(s) 964 may be functional safety level ASIL B. In some examples, the vehicle 900 may include multiple LIDAR sensors 964 (e.g., two, four, six, etc.) that may use Ethernet (e.g., to provide data to a Gigabit Ethernet switch).

In some examples, the LIDAR sensor(s) 964 may be capable of providing a list of objects and their distances for a 360-degree field of view. Commercially available LIDAR sensor(s) 964 may have an advertised range of approximately 900 m, with an accuracy of 2 cm-3 cm, and with support for a 900 Mbps Ethernet connection, for example. In some examples, one or more non-protruding LIDAR sensors 964 may be used. In such examples, the LIDAR sensor(s) 964 may be implemented as a small device that may be embedded into the front, rear, sides, and/or corners of the vehicle 900. The LIDAR sensor(s) 964, in such examples, may provide up to a 120-degree horizontal and 35-degree vertical field-of-view, with a 200 m range even for low-reflectivity objects. Front-mounted LIDAR sensor(s) 964 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 900. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LIDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984 (A)-984 (H) (collectively referred to herein as GPUs 984), PCIe switches 982 (A)-982 (H) (collectively referred to herein as PCIe switches 982), and/or CPUs 980 (A)-980 (B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: obtaining, using one or more sensors associated with a machine, sensor data representative of one or more images of an environment; obtaining data representative of one or more depth distribution maps indicative of one or more distances, relative to the one or more sensors, associated with one or more locations in the environment that correspond to one or more pixels of the one or more images; determining, based at least on one or more machine learning models processing the sensor data and the data representative of the one or more depth distribution maps, one or more depth values associated with one or more objects in the environment; and performing one or more operations associated with the machine based at least on the one or more depth values.

B. The method as recited in paragraph A, wherein the one or more distances comprise one or more average distances, relative to the one or more sensors, associated with the one or more locations in the environment, the one or more average distances determined based at least on one or more second images obtained using one or more second sensors associated with one or more second machines.

C. The method as recited in any one of paragraphs A-B, further comprising generating, based at least on ground truth data obtained from second sensor data captured using one or more second sensors, the data representative of the one or more depth distribution maps, the data including one or more points having one or more values corresponding to the one or more distances.

D. The method as recited in any one of paragraphs A-C, further comprising: modifying one or more tensors to include one or more channels corresponding to the data representative of the one or more depth distribution maps; and applying the one or more tensors including the one or more channels to the one or more machine learning models.

E. The method as recited in any one of paragraphs A-D, further comprising: generating second data representative of one or more two-dimensional (2D) coordinates, the second data representing one or more points having one or more values corresponding to one or more second locations within a three-dimensional (3D) space associated with the environment, wherein the determining the one or more depth values is further based at least on the one or more machine learning models processing the second data.

F. The method as recited in any one of paragraphs A-E, wherein the one or more values represented by the second data further correspond to one or more coordinate values of the one or more 2D coordinates, the one or more coordinate values increasing linearly in magnitude from a bottom portion of a frame to a top portion of the frame.

G. The method as recited in any one of paragraphs A-F, further comprising determining, based at least on the one or more machine learning models processing the sensor data and the data representative of the one or more depth distribution maps, one or more predicted locations of the one or more objects in the environment, the one or more objects depicted in the one or more images of the environment.

H. The method as recited in any one of paragraphs A-G, wherein a first depth distribution map of the one or more depth distribution maps corresponds to a first sensor of the one or more sensors and a second depth distribution map of the one or more depth distribution maps corresponds to a second sensor of the one or more sensors, the first sensor having a different point of view associated with the environment than the second sensor.

I. A system comprising: one or more processors to: obtain first data including one or more first points having one or more first values corresponding to one or more first locations within a three-dimensional (3D) space associated with an environment; obtain second data including one or more second points having one or more second values corresponding to one or more distances associated with one or more second locations within the environment; and apply at least one of the first data or the second data to one or more machine learning models.

J. The system as recited in paragraph I, wherein the application of the at least one of the first data or the second data to the one or more machine learning models comprises: updating one or more tensors to include one or more channels corresponding to at least one of the first data or the second data; and applying the one or more tensors including the one or more channels to one or more convolutional layers associated with the one or more machine learning models.

K. The system as recited in any one of paragraphs I-J, wherein the first data is representative of one or more two-dimensional (2D) coordinates associated with one or more frames of sensor data, the one or more first values increasing linearly in magnitude from a bottom of the one or more frames to a top of the one or more frames.

L. The system as recited in any one of paragraphs I-K, wherein the second data represents a depth distribution indicative of average distances between a sensor and locations in the environment, the locations corresponding to pixels included in images captured using the sensor.

M. The system as recited in any one of paragraphs I-L, the one or more processors further to: obtain, using one or more sensors associated with a machine, sensor data representing one or more images of an environment; apply, in association with at least one of the first data or the second data, the one or more images to the one or more machine learning models; and cause a machine to perform one or more control operations based at least on one or more predictions determined using the one or more machine learning models.

N. The system as recited in any one of paragraphs I-M, wherein the one or more predictions determined using the one or more machine learning models comprise one or more predicted locations of one or more objects depicted in the one or more images of the environment.

O. The system as recited in any one of paragraphs I-N, the one or more processors further to generate the second data based at least on ground truth data indicating one or more measured distances associated with the one or more second locations within the environment, the ground truth data generated based at least on sensor data obtained using one or more sensors of one or more machines.

P. The system as recited in any one of paragraphs I-O, wherein the one or more first points of the first data are representative of one or more first coordinates associated with a first dimension of a two-dimensional (2D) coordinate system, the one or more processors further to obtain third data including one or more third points having one or more third values corresponding to one or more third locations within the 3D space, the one or more third points representative of one or more second coordinates associated with a second dimension of the 2D coordinate system.

Q. The system as recited in any one of paragraphs I-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. At least one processor comprising: one or more circuits to perform one or more operations associated with a machine based at least on one or more depth values computed using one or more machine learning models, wherein the one or more depth values are computed by modifying one or more inputs applied to the one or more machine learning models to include data representative of one or more average distances associated with one or more locations in an environment that correspond to one or more pixels included in one or more images applied to the one or more machine learning models.

S. The processor as recited in paragraph R, wherein the determining the one or more depth values is by modifying the one or more inputs to include second data representative of one or more two-dimensional coordinates associated with the one or more images applied to the one or more machine learning models, the second data including one or more second points having one or more values corresponding to one or more second locations within a three-dimensional (3D) space associated with the environment.

T. The processor as recited in any one of paragraphs R or S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining, using one or more sensors associated with a machine, sensor data representative of one or more images of an environment;
obtaining data representative of one or more depth distribution maps indicative of one or more distances, relative to the one or more sensors, associated with one or more locations in the environment that correspond to one or more pixels of the one or more images;
determining, based at least on one or more machine learning models processing the sensor data and the data representative of the one or more depth distribution maps, one or more depth values associated with one or more objects in the environment; and
performing one or more operations associated with the machine based at least on the one or more depth values.

2. The method of claim 1, wherein the one or more distances comprise one or more average distances, relative to the one or more sensors, associated with the one or more locations in the environment, the one or more average distances determined based at least on one or more second images obtained using one or more second sensors associated with one or more second machines.

3. The method of claim 1, further comprising generating, based at least on ground truth data obtained from second sensor data captured using one or more second sensors, the data representative of the one or more depth distribution maps, the data including one or more points having one or more values corresponding to the one or more distances.

4. The method of claim 1, further comprising:
modifying one or more tensors to include one or more channels corresponding to the data representative of the one or more depth distribution maps; and
applying the one or more tensors including the one or more channels to the one or more machine learning models.

5. The method of claim 1, further comprising:
generating second data representative of one or more two-dimensional (2D) coordinates, the second data representing one or more points having one or more values corresponding to one or more second locations within a three-dimensional (3D) space associated with the environment,
wherein the determining the one or more depth values is further based at least on the one or more machine learning models processing the second data.

6. The method of claim 5, wherein the one or more values represented by the second data further correspond to one or more coordinate values of the one or more 2D coordinates, the one or more coordinate values increasing linearly in magnitude from a bottom portion of a frame to a top portion of the frame.

7. The method of claim 1, further comprising determining, based at least on the one or more machine learning models processing the sensor data and the data representative of the one or more depth distribution maps, one or more predicted locations of the one or more objects in the environment, the one or more objects depicted in the one or more images of the environment.

8. The method of claim 1, wherein a first depth distribution map of the one or more depth distribution maps corresponds to a first sensor of the one or more sensors and a second depth distribution map of the one or more depth distribution maps corresponds to a second sensor of the one or more sensors, the first sensor having a different point of view associated with the environment than the second sensor.

9. A system comprising:
one or more processors to:
obtain first data including one or more first points having one or more first values corresponding to one or more first locations within a three-dimensional (3D) space associated with an environment;
obtain second data including one or more second points having one or more second values corresponding to one or more distances associated with one or more second locations within the environment; and
apply at least one of the first data or the second data to one or more machine learning models.

10. The system of claim 9, wherein the application of the at least one of the first data or the second data to the one or more machine learning models comprises:
updating one or more tensors to include one or more channels corresponding to at least one of the first data or the second data; and
applying the one or more tensors including the one or more channels to one or more convolutional layers associated with the one or more machine learning models.

11. The system of claim 9, wherein the first data is representative of one or more two-dimensional (2D) coordinates associated with one or more frames of sensor data, the one or more first values increasing linearly in magnitude from a bottom of the one or more frames to a top of the one or more frames.

12. The system of claim 9, wherein the second data represents a depth distribution indicative of average distances between a sensor and locations in the environment, the locations corresponding to pixels included in images captured using the sensor.

13. The system of claim 9, the one or more processors further to:
obtain, using one or more sensors associated with a machine, sensor data representing one or more images of an environment;
apply, in association with at least one of the first data or the second data, the one or more images to the one or more machine learning models; and
cause a machine to perform one or more control operations based at least on one or more predictions determined using the one or more machine learning models.

14. The system of claim 13, wherein the one or more predictions determined using the one or more machine learning models comprise one or more predicted locations of one or more objects depicted in the one or more images of the environment.

15. The system of claim 9, the one or more processors further to generate the second data based at least on ground truth data indicating one or more measured distances associated with the one or more second locations within the environment, the ground truth data generated based at least on sensor data obtained using one or more sensors of one or more machines.

16. The system of claim 9, wherein the one or more first points of the first data are representative of one or more first coordinates associated with a first dimension of a two-dimensional (2D) coordinate system, the one or more processors further to obtain third data including one or more third points having one or more third values corresponding to one or more third locations within the 3D space, the one or more third points representative of one or more second coordinates associated with a second dimension of the 2D coordinate system.

17. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. At least one processor comprising:
one or more circuits to perform one or more operations associated with a machine based at least on one or more depth values computed using one or more machine learning models, wherein the one or more depth values are computed by modifying one or more inputs applied to the one or more machine learning models to include data representative of one or more average distances associated with one or more locations in an environment that correspond to one or more pixels included in one or more images applied to the one or more machine learning models.

19. The processor of claim 18, wherein the determining the one or more depth values is by modifying the one or more inputs to include second data representative of one or more two-dimensional coordinates associated with the one or more images applied to the one or more machine learning models, the second data including one or more second points having one or more values corresponding to one or more second locations within a three-dimensional (3D) space associated with the environment.

20. The processor of claim 18, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
